(19) United States
(12) Patent Application Publication
(10) Pub. No.: US 2004/0249718 A1
(43) Pub. Date: Dec. 9, 2004

(54) POS terminal device, POS terminal system, POS terminal control method, and computer product

(75) Inventors: Toshiaki Kuroda, Kawasaki (JP); Yasuhira Kushida, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/775,142

(22) Filed: Feb. 11, 2004

(30) Foreign Application Priority Data
Jun. 3, 2003 (JP) 2003-158451

(51) Int. Cl. G06F 17/60

(52) U.S. Cl. 705/17

(57) ABSTRACT

A point of sale terminal device is capable of communicating information with an automatic change dispenser that is capable of accepting and dispensing cash. The point of sale terminal device includes a deposit input unit that receives from the automatic change dispenser, deposit information that is information on an amount of cash accepted by the automatic change dispenser, an input unit to manually input information on an amount of cash rejected by the automatic change dispenser, and a calculation unit that calculates total amount of cash by adding the deposit information and the information input.

### BACKGROUND OF THE INVENTION

1) Field of the Invention

The present invention relates to a point of sale (POS) terminal system in which an automatic change dispenser receives and notes or coins from a customer and rejects the notes or coins if they are not in desirable form, and a cashier receives the notes or coins rejected by the automatic change dispenser and inputs into a point of sales terminal device the total amount of cash rejected by the automatic change dispenser.

2) Description of the Related Art

POS terminal systems are used at various places such as convenience stores and supermarkets. In the POS terminal systems, a cashier inputs, into an automatic change dispenser, an amount of money he/she has received from a customer for buying goods, and also inputs prices of the goods purchased by the customer. From those inputs, the automatic change dispenser calculates and discharges an amount of cash to be returned to the customer.

Japanese Patent Application Laid-Open No. H7-98787 (see page 2) discloses a goods sales data processor that can accept, instead of manual input of digits, notes and/or coins directly and calculate the amount of money input. Japanese Patent Application Laid-Open No. H5-73769 (see page 1) discloses a POS system that can accepts, instead of manual input of digits, input of the prices of the goods by reading bar codes attached to the goods.

The notes or the coins may not be always in acceptable form because of damage or dirt. The goods sales data processor disclosed in Japanese Patent Application Laid-Open No. H7-98787 does not accept the notes or the coins that are not in acceptable form. If the goods sales data processor does not accept the notes or the coins, then the cashier receives those notes or coins, and does all the rest of the processing manually. As a result, the processing efficiency lowers. Moreover, because the cashier receives the notes or the coins instead of the goods sales data processor, such notes or coins can not be managed automatically, and a different system is required to manage those notes or coins. As a result, the work efficiency of the totaling operation lowers.

### SUMMARY OF THE INVENTION

It is an object of the present invention to solve at least the problems in the conventional technology.

A point of sale terminal device according to an aspect of the present invention is capable of communicating information with the automatic change dispenser capable of accepting and dispensing cash. The point of sale terminal device includes a deposit input unit that receives from the automatic change dispenser, deposit information that is information on an amount of cash accepted by the automatic change dispenser; an input unit to manually input information on an amount of cash rejected by an automatic change dispenser; and a calculation unit that calculates total amount of cash by adding the deposit information and the information input.

A point of sale terminal system according to another aspect of the present invention includes a point of sale terminal device and an automatic change dispenser capable of accepting and dispensing cash. The POS terminal device includes a deposit input unit that receives from the automatic change dispenser, deposit information that is information on an amount of cash accepted by the automatic change dispenser; an input unit to manually input information on an amount of cash rejected by the automatic change dispenser; and a calculation unit that calculates total amount of cash by adding the deposit information and the information input.

A method according to still another aspect of the present invention is a method of controlling a point of sale terminal device. The point of sale terminal device is capable of communicating information with an automatic change dispenser that is capable of accepting and dispensing cash. The method includes receiving from the automatic change dispenser, deposit information that is information on an amount of cash accepted by the automatic change dispenser; manually inputting information on an amount of cash rejected by the automatic change dispenser; and calculating total amount of cash by adding the deposit information and the information input.

A computer program according to still another aspect of the present invention realizes the method according to the above aspect on a computer.

The other objects, features, and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a perspective of a POS terminal system according to a first embodiment of the present invention;

FIG. 2 is a functional block diagram of a POS terminal device according to the first embodiment;

FIG. 3 illustrates an example of transaction information;

FIG. 4 illustrates an example of data structure of total information;

FIG. 5 is a flowchart of processing performed by the POS terminal system according to the first embodiment;

FIGS. 6A and 6B illustrate one example of a screen displayed on a cashier display;

FIG. 7 illustrates an example of a cash report receipt output to a printer;

FIG. 8 is a functional block diagram of a POS terminal device according to a second embodiment of the present invention;

FIG. 9 is a flowchart of processing performed by the POS terminal system according to the second embodiment;

FIG. 10 illustrates an example of a screen displayed on a cashier display;

FIG. 11 is a functional block diagram illustrating the configuration of a computer system that executes a computer program (hereinafter, “POS terminal control program”) according to the first and the second embodiments;

FIG. 12 is a functional block diagram illustrating the system configuration of a POS system according to a third embodiment of the present invention;

FIG. 13 is a functional block diagram of a POS terminal control program executed by a server; and

FIG. 14 is a functional block diagram illustrating the configuration of a peripheral equipment control program executed by the POS terminal device.

### DETAILED DESCRIPTION

Exemplary embodiments of a POS terminal device, a POS terminal system, a POS terminal control method, and a POS terminal control program according to the present invention will be explained in detail, with reference to the accompanying drawings.

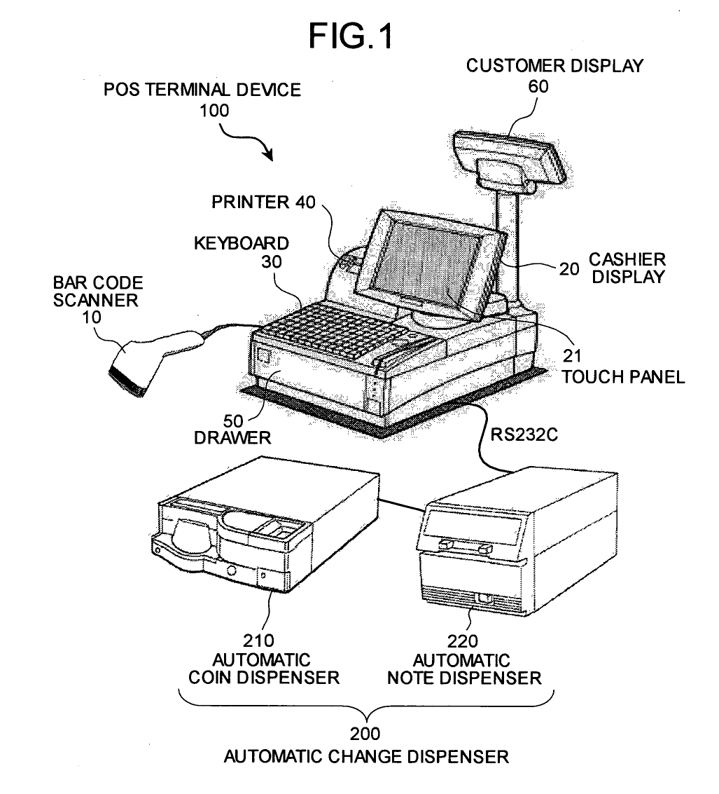

FIG. 1 is a perspective view illustrating the external configuration of the POS terminal system according to a first embodiment.

The POS terminal system includes a POS terminal device 100, an automatic coin dispenser 210, and an automatic note dispenser 220, and the automatic coin dispenser 210 and the automatic note dispenser 220 are connected to the POS terminal device 100 via, for example, RS232C.

The POS terminal device 100 is a device that reads information of a bar code attached to goods purchased by a customer, calculates a total price (hereinafter, “purchased amount”) of the goods, and also calculates how much change is to be returned to the customer. The POS terminal device 100 includes a bar code scanner 10, a cashier display 20, a touch panel 21, a keyboard 30, a printer 40, a drawer 50, and a customer display 60.

The bar code scanner 10 is a device that reads the bar code of the goods purchased by the customer, and the cashier display 20 displays the name and the price of the goods having the bar code read by the bar code scanner 10, the purchased amount, and the like to the cashier. The touch panel 21 is used to input figures or instructions to the POS terminal device 100.

The keyboard 30 is a device by which the cashier performs input of figures or gives an instruction to the POS terminal device 100. A part of the keys on the keyboard 30 is also arranged on the touch panel 21, and for those partial keys, the cashier can use keys either on the touch panel 21 or on the keyboard 30.

The printer 40 is a device that prints receipts handed to customers and cash report receipts totaling cash in and out situations. The drawer 50 is a drawer for storing cash that is not accepted by the automatic coin dispenser 210 or the automatic note dispenser 220. The customer display 60 displays the unit price of purchased goods and the sum total to the customer.

The POS terminal device 100 is connected to a server via a network, and the information of the sold goods is immediately transferred to the server and added up. The details of the POS terminal device 100 will be described later.

The automatic coin dispenser 210 is a device that receives or discharges coins. The automatic coin dispenser 210 calculates the amount of money received in the form of coins from the customer and reports it to the POS terminal device 100, and when there is change to be paid by coins, discharges coins for the change.

The automatic note dispenser 220 is a device that receives or discharges notes. The automatic note dispenser 220 calculates the amount of money received in the form of notes from the customer and reports it to the POS terminal device 100, and when there is change to be paid by notes, discharges notes for the change.

The automatic coin dispenser 210 and the automatic note dispenser 220 constitute an automatic change dispenser 200. The automatic change dispenser 200 is connected to the POS terminal device 100 via the RS232C, receives an instruction from the POS terminal device 100 and transfers the calculated amount to the POS terminal device 100.

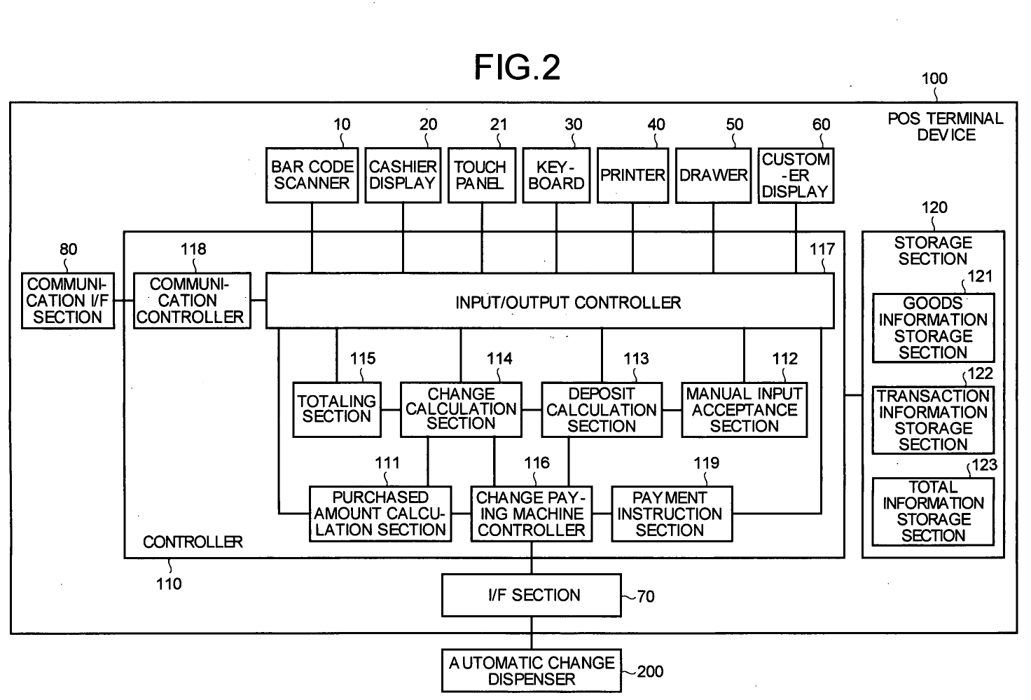

FIG. 2 is a functional block diagram illustrating the configuration of the POS terminal device 100.

The POS terminal device 100 includes an interface (I/F) section 70, a communication I/F section 80, a controller 110, and a storage section 120, in addition to the bar code scanner 10, the cashier display 20, the touch panel 21, the keyboard 30, the printer 40, the drawer 50, and the customer display 60, illustrated in FIG. 1.

The I/F section 70 is an interface for connecting the automatic change dispenser 200 to the POS terminal device 100 via, for example, RS232C. The communication I/F section 80 is an interface for connecting the POS terminal device 100 to the network.

The controller 110 is a processor that controls the POS terminal device 100. The controller 110 includes a purchased amount calculation section 111, a manual input acceptance section 112, a deposit calculation section 113, a change calculation section 114, a totaling section 115, a change dispenser controller 116, an input/output controller 117, a communication controller 118, and a payment instruction section 119.

The purchased amount calculation section 111 is a processor that receives information read from the bar code by the bar code scanner 10 via the input/output controller 117, and calculates the purchased amount from the unit price and the number of the goods purchased by the customer. The information relating to the name and the unit price of the goods purchased by the customer and the purchased amount is displayed on the cashier display 20 and the customer display 60.

The manual input acceptance section 112 is a processor that accepts the amount of money from the cashier that has not been accepted by the automatic change dispenser 200, of the deposit from the customer. In other words, the manual input acceptance section 112 receives the amount of money manually input by the cashier, using the keyboard 30 or the touch panel 21, via the input/output controller 117.

The deposit calculation section 113 is a processor that calculates the deposit amount, by adding the manual input amount received by the manual input acceptance section 112 to the amount input by the dispenser and calculated by the automatic change dispenser 200, of the deposit from the customer.

In other words, the deposit calculation section 113 receives the amount input by the dispenser, via the change dispenser controller 116 and the I/F section 70, and when there is the manual input amount, that is, when there is a note or coin that has not been accepted by the automatic change dispenser 200, calculates the deposit amount from the customer, by adding the manual input amount to the amount input by the automatic change dispenser. The deposit calculation section 113 also outputs the calculated deposit amount on the cashier display 20 and the customer display 60, via the input/output controller 117.

Since the deposit calculation section 113 calculates the deposit amount by adding the manual input amount to the amount input by the dispenser, even when a part of the deposit includes a note or coin that cannot be accepted by the automatic change dispenser 200, the automatic change 200 can automatically control the remaining part of the deposit, thereby enlarging the automatic processing range of the deposit.

The change calculation section 114 is a processor that receives the purchased amount from the purchased amount calculation section 111, and also receives the deposit amount from the deposit calculation section 113, to calculate the amount of change.

The change calculation section 114 reports the calculated amount to the automatic change dispenser 200 as the amount to be discharged as change from the automatic change dispenser, via the change dispenser controller 116 and the I/F section 70, and instructs to discharge the change. The change calculation section 114 also outputs the calculated amount of change on the cashier display 20 and the customer display 60, via the input/output controller 117.

The totaling section 115 is a processor that totals the amount input by the dispenser, the manual input amount, and the amount to be discharged by the dispenser, at the time of finishing one transaction processing, that is, the processing with respect to one customer, and adds the amount input by the dispenser, the manual input amount, and the amount to be discharged by the dispenser for the finished transaction, to the latest cumulative total value of the amount input by the dispenser, the manual input amount, and the amount to be discharged by the dispenser.

The totaling section 115 creates a cash report receipt unifying the situations of money received and paid by the POS terminal system, according to the instruction from the cashier, and outputs it to the printer 40 via the input/output controller 117.

The change dispenser controller 116 is a processor that controls the automatic change dispenser 200 via the I/F section 70, and receives the amount input by the dispenser from the automatic change dispenser 200, and instructs the automatic change dispenser 200 to discharge the change.

The input/output controller 117 is a processor that controls the bar code scanner 10, the cashier display 20, the touch panel 21, the keyboard 30, the printer 40, the drawer 50, and the customer display 60, and instructs input and output and transfers input/output data, between other functional sections in the controller 110 and the input/output controller 117.

The communication controller 118 is a processor that communicates with the server via the communication I/F section 80 and the network, and transmits goods sales information to the server on the real time basis.

The payment instruction section 119 is a processor that when a customer requests to cancel the transaction after having input the deposit to the automatic change dispenser automatic change, and the cashier presses a “cancellation” key on the touch panel 21 or on the keyboard 30, receives the cancellation instruction from the input/output controller 117, and instructs the automatic change dispenser 200 to refund the deposit.

The storage section 120 is a memory that stores the information relating to goods and transactions, and has a goods information storage section 121, a transaction information storage section 122, and a total information storage section 123.

The goods information storage section 121 is a storage section that associates the bar code, the product name, and the unit price with each other and stores these, and the goods information storage section 121 is referred when the purchased amount calculation section 111 calculates the purchased amount from the bar code.

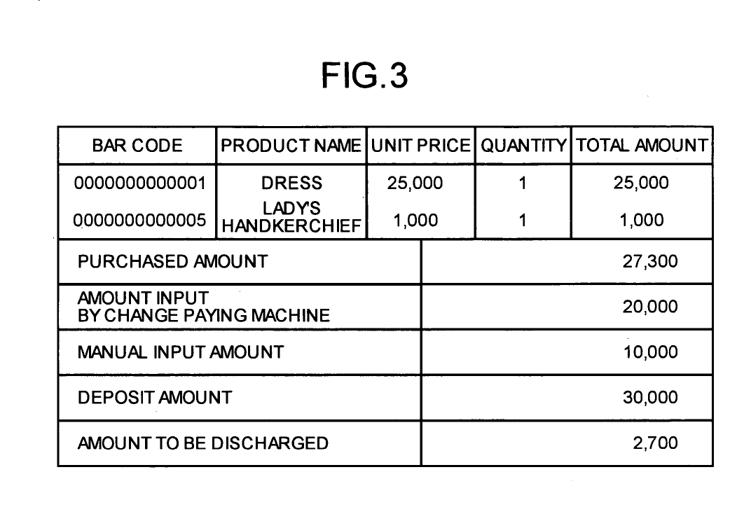

The transaction information storage section 122 is a storage section that stores the transaction information for each transaction. FIG. 3 illustrates an example of the transaction information stored in the transaction information storage section 122. As illustrated in FIG. 3, each transaction information includes the bar code for each transacted product, the product name, the unit price, the quantity and the total amount, the purchased amount, the amount input by the automatic change dispenser, the manual input amount, the deposit amount, and the amount to be discharged by the automatic change dispenser.

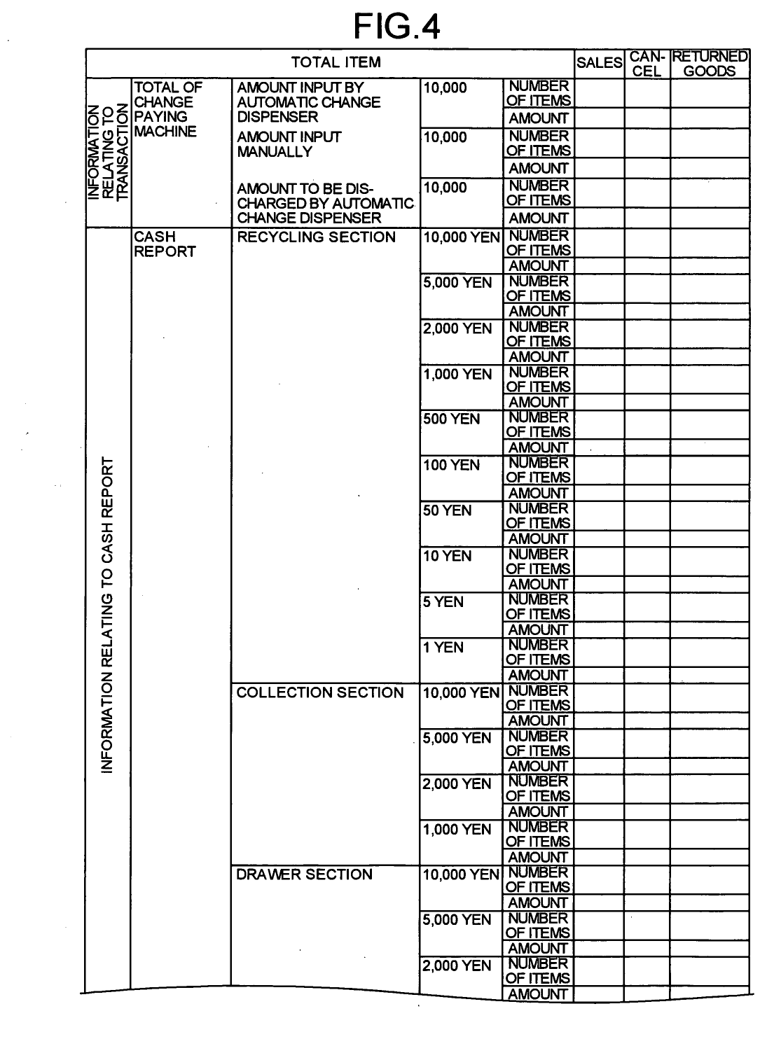

The total information storage section 123 is a storage section that stores the total information relating to the transaction, and the total information relating to the cash report. FIG. 4 illustrates an example of the data structure of the total information stored in the total information storage section 123.

As illustrated in FIG. 4, the total information includes the total of the amount input by the automatic change dispenser, the manual input amount, and the amount to be discharged by the automatic change dispenser, as the total information relating to the transaction, and the total for each type of cash stored in a recycling section, a collection section, and a drawer section of the automatic change dispenser 200, as the total information relating to the cash report.

The recycling section is a storage section that stores, for each type, money recycled as the change, of the money input to the automatic change dispenser 200. The collection section is a storage section that stores money such as 10,000 Yen note that is not reused as the change, or when the recycled money exceeds a predetermined number, stores the excess money for each type. The drawer section is the drawer 50 that stores money that has not been accepted by the automatic change dispenser 200, for each type. Further, the adding up is carried out for each sales, cancellation by cash, and returned goods from customers, with respect to the number of items and the amount.

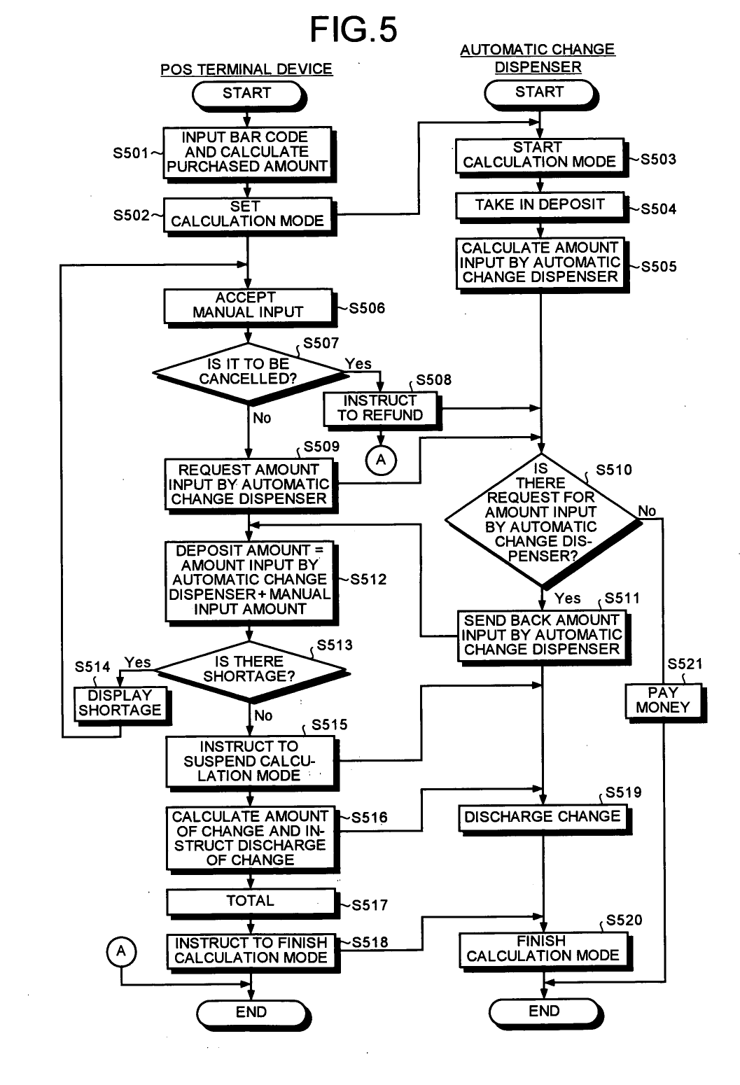

The processing procedure of the POS terminal system according to the first embodiment will be explained. FIG. 5 is a flowchart of processing performed by the POS terminal system according to the first embodiment.

As illustrated in FIG. 5, in this POS terminal system, the purchased amount calculation section 111 in the POS terminal device 100 sequentially inputs the bar codes read by the bar code scanner 10 to calculate the purchased amount (step S501). When the cashier presses a “sub total” key on the touch screen 21 or on the keyboard 30, the automatic change dispenser 200 is set to a calculation mode so that the automatic change dispenser 200 can calculate the deposit input by the cashier (step S502).

The automatic change dispenser 200 then starts the calculation mode (step S503), to take in the deposit (step S504), and calculate the amount input by the dispenser (step S505).

When there is a note or a coin that has not been accepted by the automatic change dispenser 200, the manual input acceptance section 112 in the POS terminal device 100 accepts manual input by the cashier (step S506).

When the customer requests cancellation of the transaction (step S507, Yes), the payment instruction section 119 in the POS terminal device 100 instructs the automatic change dispenser 200 to refund the amount input by the dispenser (step S508), to finish the processing.

In FIG. 5, an example in which after the manual input by the cashier has been accepted, there is a request for cancellation of the transaction is illustrated. The cancellation request can be similarly processed, even before accepting the manual input, if it is after the automatic change dispenser 200 has taken in the deposit.

On the other hand, when there is no cancellation request from the customer (step S507, No), and when the cashier presses a “deposit total” key on the touch panel 21 or on the keyboard 30 to instruct completion of the transaction, the deposit calculation section 113 in the POS terminal device 100 requests the automatic change dispenser 200 to transmit the amount input by the dispenser (step S509).

When having received the transmission request of the amount input by the dispenser from the POS terminal device 100 (step S510, Yes), the automatic change dispenser 200 sends back the amount input by the dispenser to the POS terminal device 100 (step S511), and the deposit calculation section 113 in the POS terminal device 100 calculates the deposit amount by adding the manual input amount to the amount input by the dispenser received from the automatic change dispenser 200 (step S512).

The deposit calculation section 113 then determines whether there is any shortage in the deposit amount by comparing the purchased amount with the deposit amount (step S513), and if there is a shortage in the deposit amount, displays that the deposit is not sufficient on the cashier display 20 and the customer display 60 (step S514), and waits for the next instruction from the cashier. The cashier for example requests the shortage amount to the customer and inputs the additional money into the automatic change dispenser 200, and presses the “deposit total” key again.

On the other hand, if there is no shortage in the deposit amount, the change calculation section 114 gives a suspension instruction of the calculation mode to the automatic change dispenser 200 (step S515), calculates the amount of change, and instructs discharge of the change (step S516).

The totaling section 115 respectively totals the amount input by the dispenser, the manual input amount, and the change amount (step S517), and instructs the automatic change dispenser 200 to finish the calculation mode (step S518).

The automatic change dispenser 200 discharges the change upon reception of a change discharge instruction from the POS terminal device 100 (step S519), and finishes the calculation mode upon reception of an instruction to finish the calculation mode (step S520).

On the other hand, when there is a payment instruction from the POS terminal device 100 (step S510, No), the automatic change dispenser 200 pays money, the same as the amount input by the dispenser, to finish the processing (step S521).

In this manner, the manual input acceptance section 112 accepts the amount of money that has not been accepted by the automatic change dispenser 200 as the manual input amount, and the deposit calculation section 113 adds the manual input amount to the amount input by the dispenser received from the automatic change dispenser 200 to calculate the deposit amount. As a result, the range of automatic processing by the automatic change dispenser 200 can be increased.

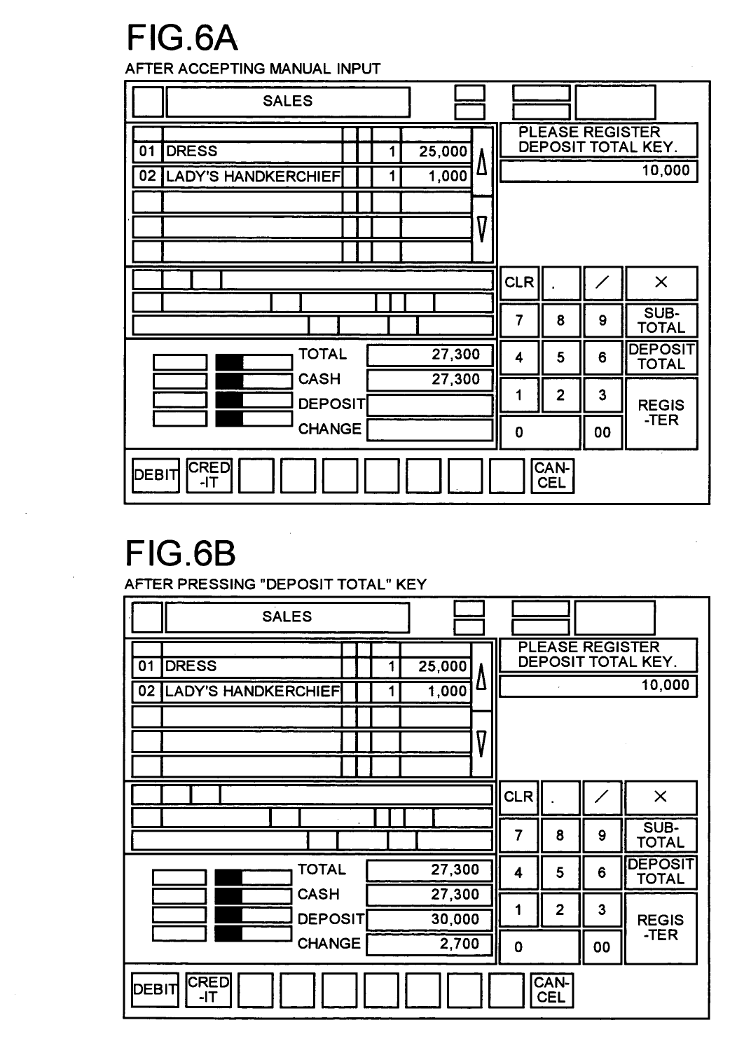

A screen displayed on the cashier display 20 by the POS terminal device 100 will be explained. FIGS. 6A and 6B illustrate one example of the screens displayed on the cashier display 20 by the POS terminal device 100.

FIG. 6A illustrates the screen after 10,000 Yen is manually input by the cashier, since 10,000 Yen note of the deposit 30,000 Yen from a customer has not been accepted by the automatic change dispenser 200. As illustrated in FIG. 6A, the value “10,000” manually input by the cashier is displayed on the upper right part of the screen.

FIG. 6B illustrates the screen after the cashier presses the “deposit total” key. As illustrated in FIG. 6B, the value “10,000” manually input by the cashier is added to the calculation value “20,000” from the automatic change dispenser 200, and “30,000” is displayed on a column “deposit” on the screen.

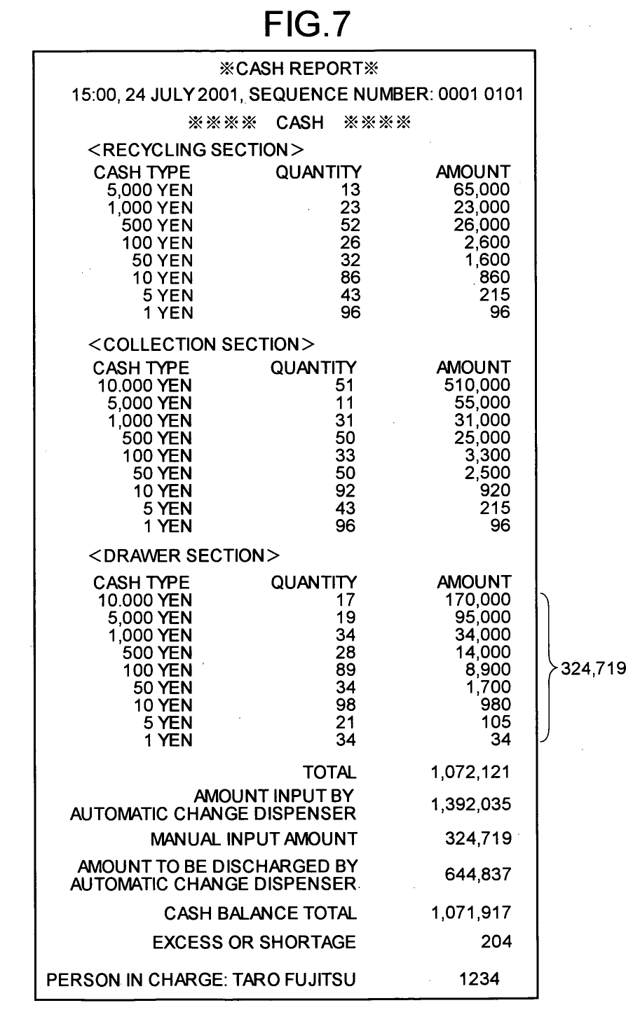

The cash report receipt output to the printer 40 by the POS terminal device 100 will be explained. FIG. 7 illustrates one example of the cash report receipt output to the printer 40 by the POS terminal device 100.

As illustrated in FIG. 7, in the cash report receipt, the cash amount stored in the recycling section, the collection section, and the drawer section is output for each type. The total of the cash stored in the recycling section, the collection section, and the drawer section is then output.

Further, the amount input by the dispenser, the manual input amount, and the amount to be discharged by the dispenser are respectively totaled and output. Thus, by separately outputting the amount input by the dispenser and the manual input amount, when the cash balance total, being the theoretical cash amount calculated by totaling the amount input by the dispenser, the manual input amount, and the amount to be discharged by the dispenser, is different from the actual cash total, it can be easily determined whether the cause is in the automatic change dispenser 200 or in the manual input.

For example, as illustrated in FIG. 7, when the cash balance total, being the theoretical cash amount, is: amount input by the dispenser+manual input amount−amount to be discharged by the dispenser=¥1,392,035+¥324,719−¥644,837=¥1,071,917, and the actual cash total is ¥1,072,121, indicating that the actual cash exceeds by ¥1,072,121−¥1,071,917=¥204, it is seen that since the total of the drawer section is ¥324,719 and is equal to the manual input amount, the manual input amount does not have any problem, and the problem is in the total of the automatic change dispenser 200.

In the first embodiment, the manual input acceptance section 112 accepts the manual input amount manually input by the cashier, and the deposit calculation section 113 adds the manual input amount accepted by the manual input acceptance section 112 to the amount input by the dispenser received from the automatic change dispenser 200 to calculate the deposit amount. Hence, even when a part of the deposit has not been accepted by the automatic change dispenser 200, the cashier needs only to control the amount that has not been accepted, and hence the range of deposit processing by the automatic change dispenser 200 can be increased, thereby enabling improvement in the efficiency of the deposit processing.

In the first embodiment, when a customer requests to cancel the transaction after having input the deposit to the automatic change dispenser 200, the payment instruction section 119 instructs payout of the deposit to the automatic change dispenser 200. Therefore, even when the transaction is cancelled, automatic control by the automatic change dispenser 200 is possible, thereby increasing the range of automatic processing of the deposit.

In the first embodiment, since the totaling section 115 separately totals the amount input by the dispenser and calculated by the automatic change dispenser 200 and the manual input amount input by the cashier, when there is an excess or shortage in the cash balance total, it can be easily determined whether the cause thereof is in the manual input or in the automatic change dispenser 200, thereby improving the efficiency of the totaling operation.

In the first embodiment, it is necessary for the cashier to input only the amount that has not been accepted by the automatic change dispenser 200, of the deposit from the customer, but when a part of the deposit has not been accepted by the automatic change dispenser 200, the cashier may manually input the full amount of the deposit by mistake. This is because in the conventional operation of the POS terminal device, when a part of the deposit has not been accepted by the automatic change dispenser 200, the cashier needs to input the full amount of the deposit manually.

In the second embodiment, therefore, a POS terminal device will be explained, in which when a part of the deposit has not been accepted by the automatic change dispenser 200, such an operation error that the cashier manually inputs the full amount of the deposit by mistake is prevented.

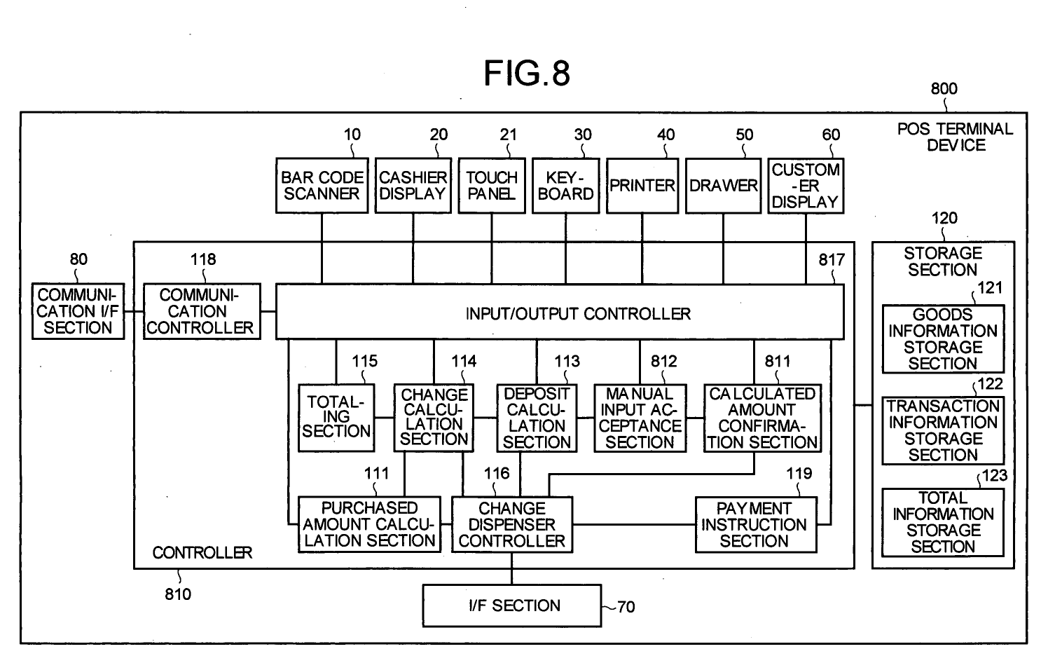

The configuration of a POS terminal device 800 according to the second embodiment will be explained. FIG. 8 is a functional block diagram illustrating the configuration of the POS terminal device 800 according to the second embodiment. For the convenience of explanation, like reference signs refer to functional sections that perform like roles as in the respective sections illustrated in FIG. 2, and the detailed explanation thereof is omitted.

As illustrated in FIG. 8, a controller 810 in the POS terminal device 800 has the purchased amount calculation section 111, a manual input acceptance section 812, the deposit calculation section 113, the change calculation section 114, the totaling section 115, the change dispenser controller 116, an input/output controller 817, the communication controller 118, the payment instruction section 119, and a calculated amount confirmation section 811.

The calculated amount confirmation section 811 is a processor that displays the amount input by the dispenser on the cashier display 20 and the customer display 60, for the confirmation of the amount input by the dispenser and calculated by the automatic change dispenser 200 from the deposit, when a “registration” key is pressed on the touch panel 21 or on the keyboard 30, after the cashier has input the deposit in the automatic change dispenser 200.

In other words, when the “registration” key is pressed, the calculated amount confirmation section 811 receives a request to confirm the amount input by the dispenser from the input/output controller 817, and requests the transmission of the amount input by the dispenser to the automatic change dispenser 200, via the change dispenser controller 116 and the I/F section 70. The calculated amount confirmation section 811 then displays the amount input by the dispenser received from the automatic change dispenser 200 on the cashier display 20 and the customer display 60 via the input/output controller 817.

The manual input acceptance section 812 accepts the manual input from the cashier, after the “registration” key is pressed, and the amount input by the dispenser and calculated by the automatic change dispenser 200 is displayed on the cashier display 20 and the customer display 60.

In this manner, when the “registration” key is pressed, the calculated amount confirmation section 811 displays the amount input by the dispenser on the cashier display 20 and the customer display 60, and after the amount input by the dispenser is displayed on the cashier display 20 and the customer display 60, the manual input acceptance section 812 accepts the manual input by the cashier. As a result, such an operation error that the cashier manually inputs the full amount of the deposit by mistake can be prevented.

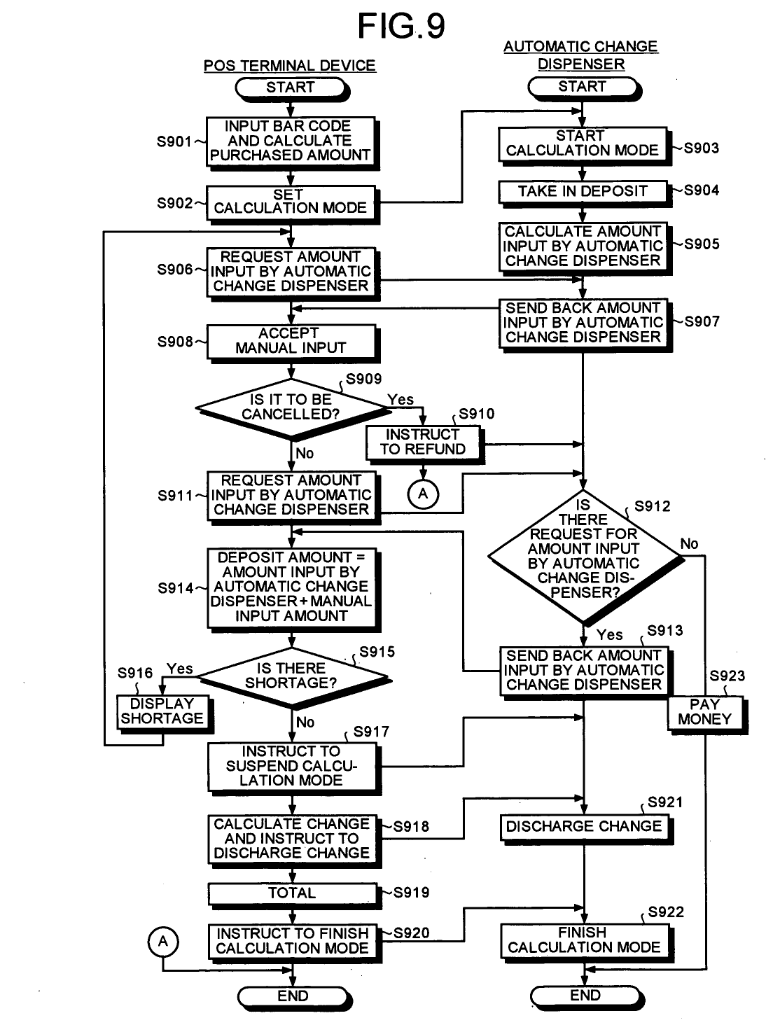

The processing procedure of the POS terminal system according to the second embodiment will be explained. FIG. 9 is a flowchart illustrating processing procedure of the POS terminal system according to the second embodiment.

As illustrated in FIG. 9, in this POS terminal system, the purchased amount calculation section 111 in the POS terminal device 800 sequentially inputs the bar codes read by the bar code scanner 10, to calculate the purchased amount (step S901). When the cashier presses the “sub total” key on the touch screen 21 or on the keyboard 30, the automatic change dispenser 200 is set to the calculation mode so that the automatic change dispenser 200 can calculate the deposit input by the cashier (step S902).

The automatic change dispenser 200 then starts the calculation mode (step S903), to take in the deposit (step S904), and calculate the amount input by the dispenser (step S905).

When the cashier presses the “registration” key on the touch screen 21 or on the keyboard 30, the calculated amount confirmation section 811 in the POS terminal device 800 requests the automatic change dispenser 200 to transmit the amount input by the dispenser (step $906), and the automatic change dispenser 200 sends back the amount input by the dispenser (step S907). The calculated amount confirmation section 811 in the POS terminal device 800 displays the received amount input by the dispenser on the cashier display 20 and the customer display 60.

Thereafter, the manual input acceptance section 812 in the POS terminal device 800 accepts input of the amount of money that has not been accepted by the automatic change dispenser 200 (step S908).

Further, when the customer requests cancellation of the transaction (step S909, Yes), the payment instruction section 119 in the POS terminal device 800 instructs the automatic change dispenser 200 to refund the amount input by the dispenser (step S910), to finish the processing.

On the other hand, when there is no request for cancellation from the customer (step S909, No), and when the cashier presses the “deposit total” key on the touch panel 21 or on the keyboard 30 to instruct completion of the transaction, the deposit calculation section 113 in the POS terminal device 800 requests the automatic change dispenser 200 to transmit the amount input by the dispenser (step S911).

When having received the transmission request of the amount input by the dispenser from the POS terminal device 800 (step S912, Yes), the automatic change dispenser 200 sends back the amount input by the dispenser to the POS terminal device 800 (step S913), and the deposit calculation section 113 in the POS terminal device 800 adds the manual input amount to the received amount input by the dispenser, to calculate the deposit amount (step S914).

The deposit calculation section 113 compares the purchased amount with the deposit amount, to determine if there is any shortage in the deposit amount (step S915), and if there is a shortage in the deposit amount, displays that the deposit is not sufficient on the cashier display 20 and the customer display 60 (step S916), and waits for the next instruction from the cashier. For example, the cashier requests the customer to pay the shortage amount, inputs additional money into the automatic change dispenser 200, and presses the “deposit total” key again.

On the other hand, if there is no shortage in the deposit amount, the change calculation section 114 instructs the automatic change dispenser 200 to suspend the calculation mode (step S917), calculates the change amount, and instructs discharge of the change (step S918).

The totaling section 115 totals the amount input by the dispenser, the manual input amount, and the change amount, respectively (step S919), and instructs the automatic change dispenser 200 to finish the calculation mode (step S920).

The automatic change dispenser 200 discharges the change upon reception of the instruction to discharge the change from the POS terminal device 800 (step S921), and finishes the calculation mode upon reception of the instruction to finish the calculation mode (step S922).

On the other hand, when having received a payment instruction from the POS terminal device 800 (step S912, No), the automatic change dispenser 200 pays money of the amount the same as the amount input by the dispenser, to finish the processing (step S923).

In this manner, when the cashier presses the “registration” key, the calculated amount confirmation section 811 obtains the amount input by the dispenser from the automatic change dispenser 200 and displays it on the cashier display 60, for the confirmation of the deposit amount, thus, such an operation error that the cashier manually inputs the full amount of the deposit by mistake can be prevented.

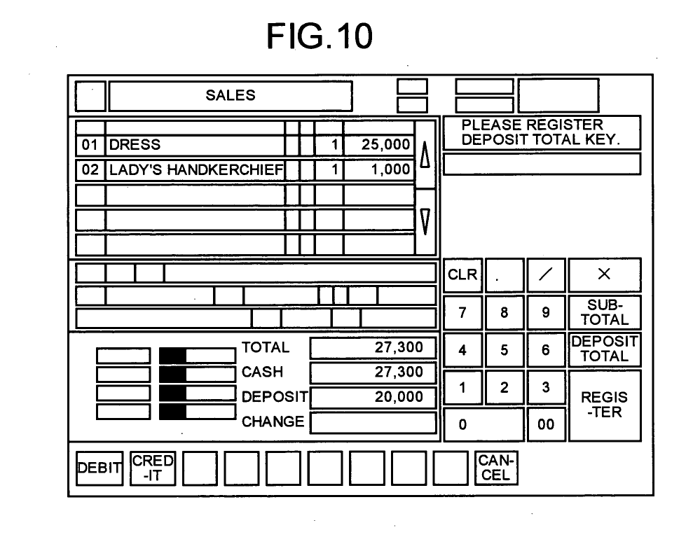

A screen displayed on the cashier display 60 by the POS terminal device 800 according to the second embodiment will be explained. FIG. 10 illustrates one example of the screen displayed on the cashier display 60 by the POS terminal device 800 according to the second embodiment.

FIG. 10 illustrates a screen after the cashier has pressed the “registration” key, when one 10,000 Yen note of 30,000 Yen of the deposit from a customer, has not been accepted by the automatic change dispenser 200. As illustrated in FIG. 10, the amount “20,000” input by the dispenser and which has been accepted by the automatic change dispenser 200 is displayed in the “deposit” portion on the screen for the confirmation.

The cashier confirms the amount in the “deposit” portion, and can manually input the amount 10,000 Yen that has not been accepted by the automatic change dispenser 200, without manually inputting the full amount 30,000 Yen of the deposit by mistake.

In the second embodiment, therefore, when the cashier presses the “registration” key on the touch panel 21 or on the keyboard 30, the calculated amount confirmation section 811 receives the amount input by the dispenser from the automatic change dispenser 200 and displays the amount on the cashier display 20. As a result, such an operation error that the cashier manually inputs the full amount of the deposit by mistake can be prevented, thereby improving the processing efficiency of the deposit.

In the first and the second embodiments, the POS terminal device has been explained. A POS terminal control program having the similar function can be obtained, by realizing the configurations of the controller and the storage section in these POS terminal devices by software.

By executing the POS terminal control program on a computer system, the POS terminal device can be realized. Therefore, the computer system that executes the POS terminal control program will be explained.

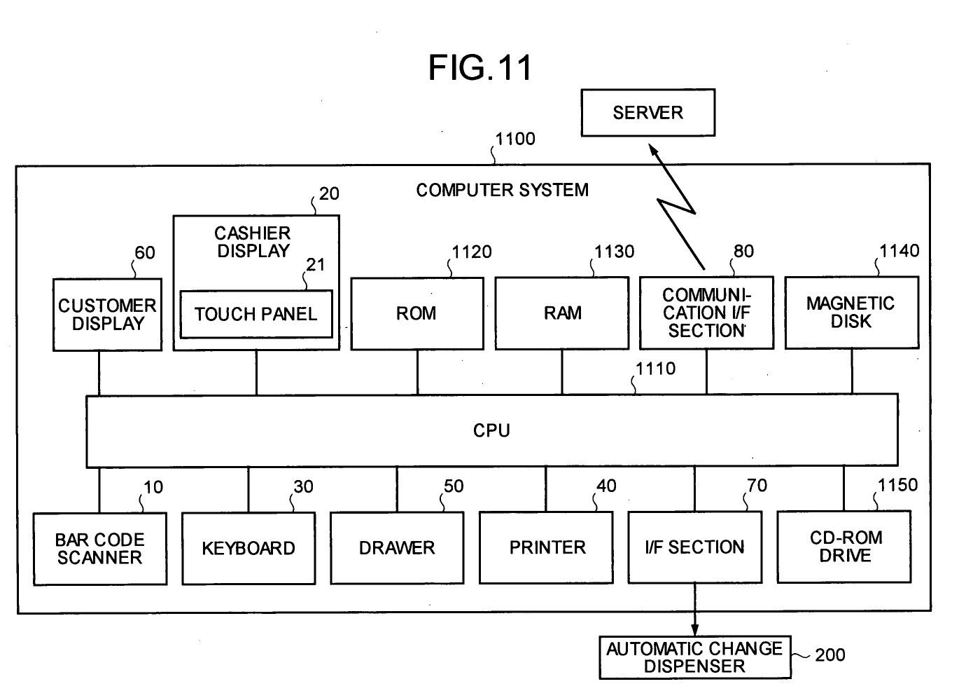

FIG. 11 is a functional block diagram illustrating the configuration of the computer system that executes the POS terminal control programs according to the first and the second embodiments. Here, for the convenience of explanation, like reference signs refer to functional sections that perform like roles as in the respective sections illustrated in FIG. 2, and the detailed explanation thereof is omitted.

As illustrated in FIG. 11, this computer system 1100 has the bar code scanner 10, the cashier display 20, the touch panel 21, the keyboard 30, the printer 40, the drawer 50, the customer display 60, the I/F section 70, the communication I/F section 80, a central processing unit (CPU) 1110, a read-only memory (ROM) 1120, a random access memory (RAM) 1130, a magnetic disk 1140, and a CD-ROM drive 1150.

The CPU 1110 is a central processing unit that executes the POS terminal control program, and the ROM 1120 is a read-only memory that stores fixed data. The RAM 1130 is a memory that stores temporary data generated at the time of executing the POS terminal control program, and the magnetic disk 1140 is a memory that stores the transaction information and the total information.

The POS terminal control program is stored in the CD-ROM, read out from the CD-ROM and installed in the computer system 1100. Alternatively, the POS terminal control program is stored in the database of a server connected via the network, read out from the database, and installed in the computer system 1100.

The POS terminal control program is stored in the magnetic disk 1140, and executed by the CPU 1110, using the RAM 1130 and the ROM 1120.

The POS terminal control program is a program executed by the computer system 1100 installed in each store, but functional sections other than the input/output controller and the dispenser controller, of the functional sections in the POS terminal control program, may be realized as a program on the server. Therefore, in the third embodiment, the POS terminal control program executed by the server will be explained.

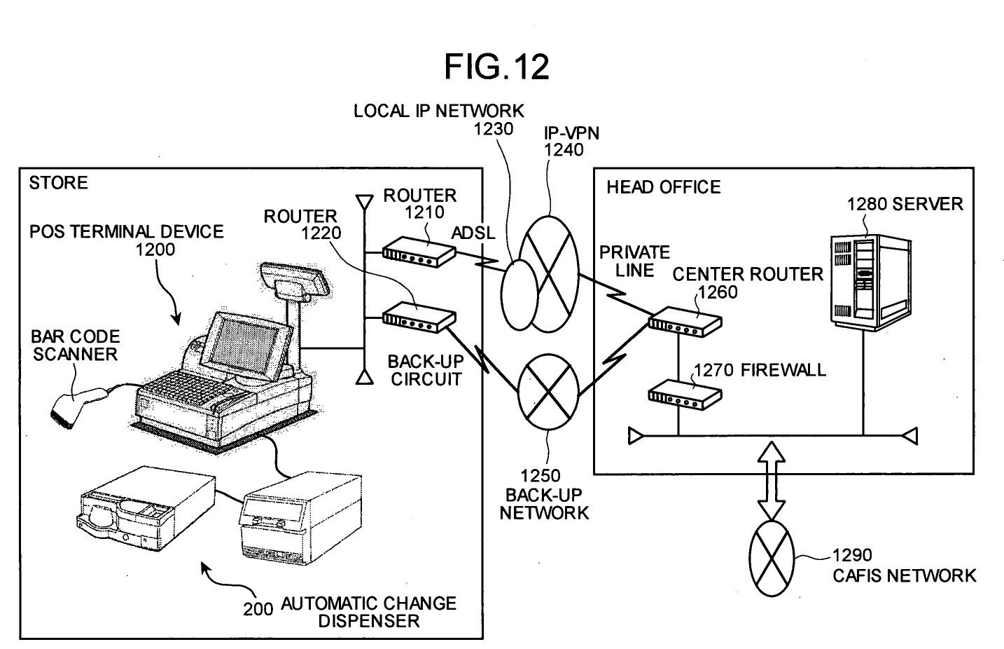

The system configuration of the POS system according to the third embodiment will be explained. FIG. 12 is a functional block diagram illustrating the system configuration of the POS system according to the third embodiment.

As illustrated in FIG. 12, this POS system is constructed such that the POS terminal device 1200 installed in the store and the server 1280 installed in the head office are connected with each other via a local Internet protocol (hereinafter, “IP”) network 1230 and an IP-virtual private network (hereinafter, “IP-VPN”) 1240. The POS terminal device 1200 is connected to the local IP network 1230 via a router 1210, and the server 1280 is connected to the IP-VPN 1240 via a firewall 1270 and a center router 1260.

In this POS system, another back-up network 1250 is used to connect the POS terminal device 1200 with the server 1280, in order to back up the local IP network 1230 and the IP-VPN 1240. In other words, the POS terminal device 1200 is connected to the back-up network 1250 via a router 1220, and the server 1280 is connected to the back-up network 1250 via the firewall 1270 and the center router 1260.

Here, for the convenience of explanation, only one POS terminal device is shown, but a plurality of POS terminal devices connected to a local area network (LAN) circuit installed in the store may be connected to the server 1280 via the local IP network 1230 and the IP-VAN 1240.

The respective POS terminal devices are realized by using a computer. The server 1280 is connected to a credit and finance information system (CAFIS) 1290.

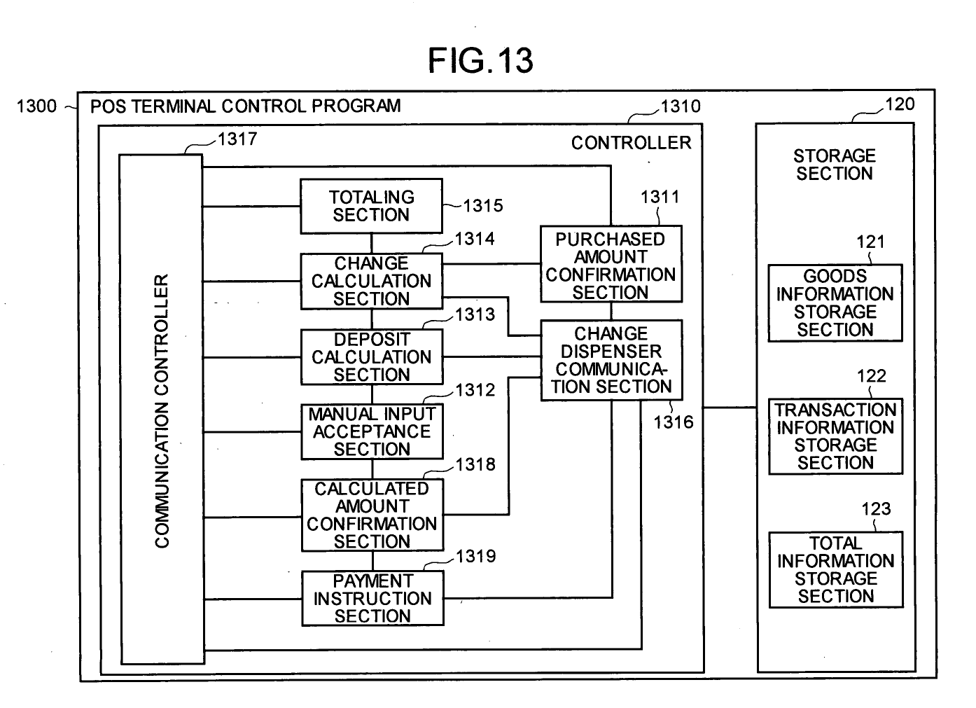

The configuration of the POS terminal control program executed by the server 1280 will be explained. FIG. 13 is a functional block diagram illustrating the configuration of the POS terminal control program executed by the server 1280.

As illustrated in FIG. 13, the POS terminal control program 1300 has a controller 1310 and a storage section 120. The controller 1310 has a purchased amount calculation section 1311, a manual input acceptance section 1312, a deposit calculation section 1313, a change calculation section 1314, a totaling section 1315, a change dispenser communication section 1316, a communication controller 1317, a calculated amount confirmation section 1318, and a payment instruction section 1319.

The communication controller 1317 is a processor that communicates with the POS terminal device 1200 via the IP-VPN 1240 and the local IP network 1230, or the back-up network 1250.

The purchased amount calculation section 1311, the manual input acceptance section 1312, the deposit calculation section 1313, the change calculation section 1314, the totaling section 1315, the calculated amount confirmation section 1318, and the payment instruction section 1319 transfer data to and from the POS terminal device 1200 via the communication controller 1317.

For example, the purchased amount calculation section 1311 receives the bar code read by the bar code scanner in the POS terminal device 1200 via the communication controller 1317, and displays information such as the product name and the unit price corresponding to the bar code, and the total sum of the purchased amount, on the cashier display of the POS terminal device 1200 via the communication controller 1317.

The dispenser controller 1316 is a processor that communicates with the automatic change dispenser 200 connected to the POS terminal 1200, and transfers data to and from the POS terminal device 1200 via the communication controller 1317.

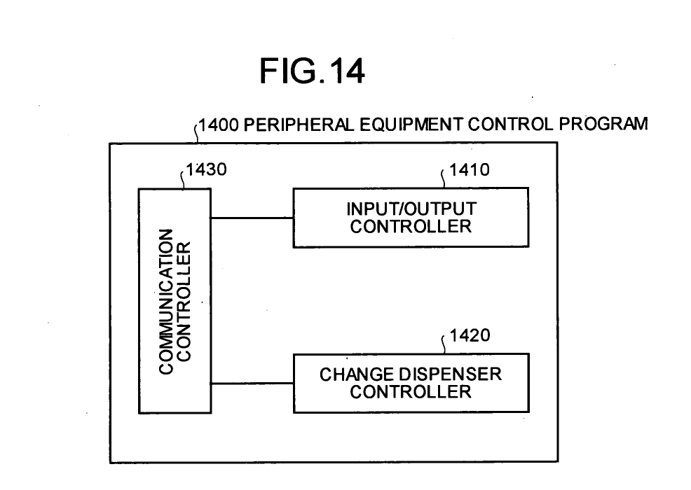

The configuration of the peripheral equipment control program executed by the POS terminal device 1200 will be explained next. FIG. 14 is a functional block diagram illustrating the configuration of the peripheral equipment control program executed by the POS terminal device 1200. As illustrated in FIG. 14, the peripheral equipment control program 1400 has an input/output controller 1410, a dispenser controller 1420, and a communication controller 1430.

The input/output controller 1410 is a processor that controls the bar code scanner, the cashier display, the touch panel, the keyboard, the printer, the drawer, and the customer display equipped in the POS terminal device 1200, and specifically, performs processing in response to the instruction from the POS terminal control program 1300 in the server 1280, via the communication controller 1430.

The dispenser controller 1420 is a processor that controls the automatic change dispenser 200 connected to the POS terminal device 1200, and specifically, performs processing in response to the instruction from the change dispenser communication section 1316 in the POS terminal control program 1300 via the communication controller 1430.

The communication controller 1430 is a processor that communicates with the POS terminal control program 1300 on the server 1280, via the local IP network 1230 and the IP-VPN 1240, or the back-up network 1250.

In the third embodiment, since functional sections other than the input/output controller and the dispenser controller, of the functional sections that control the POS terminal control devices according to the first and the second embodiments, are realized by the POS terminal control program executed in the server, program update operation due to a bug or a function enhancement of the POS terminal control program can be performed only by the server, thereby improving the maintenance efficiency of the POS system.

According to the present invention, it is possible to automatically calculate the total amount even if there are notes or coins that are not accepted by the automatic change dispenser. As a result, work efficiency can be improved and load on the operator can be reduced.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1 A point of sale terminal device capable of communicating information with the automatic change dispenser capable of accepting and dispensing cash, comprising:
a deposit input unit that receives from the automatic change dispenser, deposit information that is information on an amount of cash accepted by the automatic change dispenser;
an input unit to manually input information on an amount of cash rejected by an automatic change dispenser; and
a calculation unit that calculates total amount of cash by adding the deposit information and the information input.

2. The point of sale terminal device according to claim 1, further comprising a payment instruction unit that instructs the automatic change dispenser to refund a cash corresponding to the deposit information, when there is request for cancellation of transaction after the automatic change dispenser has accepted the cash.

3. The point of sale terminal device according to claim 1, further comprising a display unit that displays the deposit information, wherein the input unit allows the information to be input after the display unit has displayed the deposit information.

4. The point of sale terminal device according to claim 3, further comprising a key that is operated when instructing the display unit for instructing display of the deposit information, wherein the display unit displays the deposit information when the key is operated.

5. The point of sale terminal device according to claim 1, further comprising a totaling unit that separately calculates, for a predetermined period, totals of the amount of cash accepted from the deposit information and the amount of cash rejected from the information input.

6. A point of sale terminal system comprising a point of sale terminal device and an automatic change dispenser capable of accepting and dispensing cash, wherein the POS terminal device includes
a deposit input unit that receives from the automatic change dispenser, deposit information that is information on an amount of cash accepted by the automatic change dispenser;
an input unit to manually input information on an amount of cash rejected by the automatic change dispenser; and
a calculation unit that calculates total amount of cash by adding the deposit information and the information input.

7. The point of sale terminal system according to claim 6, wherein the POS terminal device further includes a payment instruction unit that instructs the automatic change dispenser to refund a cash corresponding to the deposit information, when there is request for cancellation of transaction after the automatic change dispenser has accepted the cash.

8. The point of sale terminal system according to claim 6, wherein the POS terminal device further includes a display unit that displays the deposit information, wherein the input unit allows the information to be input after the display unit has displayed the deposit information.

9. The point of sale terminal system according to claim 8, wherein the POS terminal device further includes a key that is operated when instructing the display unit for instructing display of the deposit information, wherein the display unit displays the deposit information when the key is operated.

10. The point of sale terminal system according to claim 6, wherein the POS terminal device further includes a totaling unit that separately calculates, for a predetermined period, totals of the amount of cash accepted from the deposit information and the amount of cash rejected from the information input.

11 A method of controlling a point of sale terminal device, the point of sale terminal device capable of communicating information with an automatic change dispenser capable of accepting and dispensing cash, comprising:
receiving from the automatic change dispenser, deposit information that is information on an amount of cash accepted by the automatic change dispenser;
manually inputting information on an amount of cash rejected by the automatic change dispenser; and
calculating total amount of cash by adding the deposit information and the information input.

12. The method according to claim 11, further comprising instructing the automatic change dispenser to refund a cash corresponding to the deposit information, when there is request for cancellation of transaction after the automatic change dispenser has accepted the cash.

13. The method according to claim 11, further comprising displaying the deposit information, wherein the input of the information is allowed at the manually inputting after the deposit information has been displayed.

14. The method according to claim 13, further comprising making an instruction to display the deposit information, wherein the deposit information is displayed a when the instruction has been made.

15. The method according to claim 11, further comprising separately calculating, for a predetermined period, totals of the amount of cash accepted from the deposit information and the amount of cash rejected from the information input.

16 A computer program for controlling a point of sale terminal device, the point of sale terminal device connected to an automatic change dispenser capable of accepting and dispensing cash, the computer program making the point of sale terminal device execute:
receiving from the automatic change dispenser, deposit information that is information on an amount of cash accepted by the automatic change dispenser;
manually inputting information on an amount of cash rejected by the automatic change dispenser; and
calculating total amount of cash by adding the deposit information and the information input.

17. The computer program according to claim 16, further making the point of sale terminal device execute instructing the automatic change dispenser to refund a cash corresponding to the deposit information, when there is request for cancellation of transaction after the automatic change dispenser has accepted the cash.

18. The computer program according to claim 16, further comprising displaying the deposit information, wherein the input of the information is allowed at the manually inputting after the deposit information has been displayed.

19. The computer program according to claim 16, further comprising separately calculating, for a predetermined period, totals of the amount of cash accepted from the deposit information and the amount of cash rejected from the information input.

20. A computer program for controlling a point of sale terminal device via a network, the point of sale terminal device capable of communicating information with an automatic change dispenser capable of accepting and dispensing cash, the computer program making a computer execute:
a deposit input unit that receives from the automatic change dispenser, deposit information that is information on an amount of cash accepted by the automatic change dispenser;
an input unit to manually input information on an amount of cash rejected by the automatic change dispenser; and
a calculation unit that calculates total amount of cash by adding the deposit information and the information input.

21. The computer program according to claim 20, further comprising separately calculating, for a predetermined period, totals of the amount of cash accepted from the deposit information and the amount of cash rejected from the information input.
